(19) United States
(12) Patent Application Publication
(10) Pub. No.: US 2018/0146830 A9
(43) Pub. Date: May 31, 2018

(54) TOILET PAPER DISPENSER

(71) Applicants: DAVID C. YOCOM, LIBERTY TOWNSHIP, OH (US); CANDICE B. YOCOM, LIBERTY TOWNSHIP, OH (US)

(72) Inventors: DAVID C. YOCOM, LIBERTY TOWNSHIP, OH (US); CANDICE B. YOCOM, LIBERTY TOWNSHIP, OH (US)

(73) Assignee: HANDY TISSUE, LLC, LIBERTY TOWNSHIP, OH (US)

(21) Appl. No.: 15/083,642

(22) Filed: Mar. 29, 2016

(51) Int. Cl. A47K 10/38; F21V 33/00

(52) U.S. Cl. CPC A47K 10/3836; A47K 2010/3233; F21V 33/004

(57) ABSTRACT

A toilet paper dispenser is disclosed in which the dispenser does not need to be mounted to the wall or placed on the floor. The dispenser is typically made of a one-piece construction that installs easily to any existing toilet by way of the mounting bolt for the toilet seat. The toilet paper dispenser adjustably rotates between an extended position alongside the toilet seat and a storage position behind the toilet seat and under the toilet tank. The inventive toilet paper dispenser can receive any size roil of toilet paper, and loads by sliding the roil over the open end of the dispenser. A plastic cover for protecting a loaded roil of toilet paper can be fitted to the dispenser, and one or more concealed compartments on the dispenser can provide a location for a removable fragrance cartridge and/or motion sensing LED battery-powered night light

### FIELD OF THE INVENTION

The present invention relates in general to toilet paper dispensers, and in particular to a one-piece toilet paper dispenser that can be mounted to a toilet bowl fixture.

### BACKGROUND OF THE INVENTION

Most toilet paper dispensers are mounted on a wall found adjacent to a toilet. Typically these dispensers have two short “arms” which extend from the wall and support a mandrel between them. The toilet paper roll is rotatably supported by the mandrel and toilet paper is dispensed by rotating the toilet paper roll. However, occasionally there is no wall along the side of the toilet, and even if there is a wall along the side of a toilet, ceramic-type toilet paper dispensers are difficult for a homeowner to install on their own and typically require a lot of skill and expense to replace if they break. Further, when no side wall is present, toilet paper holders and dispensers are often placed in a position where it is difficult to access when sitting upon a toilet, thus requiring undue twisting, turning and reaching.

Solutions for difficult to install, difficult to reach, and/or distantly located toilet paper dispensers can be complex in construction and typically employ telescopic components, hinges, or pivot joints. These devices generally permit only limited and awkward adjustment, and are unsuitable for a wide variety of situations. U.S. Pat. No. 7,306,185 to Miller, U.S. Pat. No. 3,228,618 to Bracken and U.S. Pat. No. 2,518,328 to Janonis each discloses a toilet paper holder for attachment to the toilet tank. These devices generally do not increase the ease with which the toilet roll can be accessed, and may present an undesirable obstruction. U.S. Pat. No. 1,226,453 to Boyle discloses a dispenser which is mounted onto a toilet seat. The dispenser generally comprises a couple of pieces of thick metal wire hinged together, with one end being attached to the toilet seat and the other end supporting a mandrel for receiving a toilet paper roll. Although this toilet paper dispenser can be positioned where a user can more easily access the toilet paper, it is unwieldy, does not retract so as to be out of the way when not in use, and projects above the level of the toilet seat creating a potentially undesirable obstruction.

Accordingly, there exists a need to provide a toilet paper dispenser which can be mounted without the benefit of an adjacent side wall extending alongside the toilet, yet which can be easily accessed for use and then placed into a storage position where it will not interfere with other uses of a restroom. It would also be advantageous to provide a toilet paper dispenser that is simple in construction, easy to install, and does not employ telescopic components, hinges or pivot joints.

### SUMMARY OF THE INVENTION

The present invention provides a toilet paper dispenser which can be mounted beneath the rear deck of a toilet bowl fixture where it can easily be accessed, yet retracted quickly and easily to be stored behind the toilet bowl. It is a one-piece design that loads by sliding a toilet paper roll over the distal end of the dispenser. A plastic cover for protecting the loaded roll of toilet paper can be fitted to the dispenser, and the dispenser can include one or more compartments for a fragrance cartridge and/or a night light. The inventive dispenser can be sized to receive any size roll of toilet paper.

A first aspect of the invention relates to a toilet paper dispenser comprising: (a) a proximal horizontal segment for mounting to a toilet bowl fixture via a mounting bolt for a toilet seat; (b) a descending segment; and (c) a distal horizontal segment for receiving a roll of toilet paper, wherein segments (a)-(c) are made of a single piece construction.

A second aspect of the invention is a toilet paper dispenser which is rotatable fix storage behind the toilet seat when not in use, the dispenser comprising: (a) a proximal horizontal segment for mounting to a toilet bowl fixture via a mounting bolt for a toilet seat, the proximal segment including a bolt hole for receiving the mounting bolt; (b) a descending segment; (c) distal horizontal segment for receiving a roll of toilet paper; and (d) a distal ascending segment for retaining the roll of toilet paper on the distal horizontal segment, wherein segments (a)-(d) are made of a single piece construction.

A third aspect of the invention relates to a method of providing easy access to a toilet paper roll, comprising: (a) mounting a toilet paper dispenser to a toilet seat via a mounting bolt for a toilet seat; (b) attaching a roll of toilet paper to the toilet paper dispenser; and (c) adjustably rotating the dispenser about the mounting bolt between: (i) an extended position alongside the toilet seat for access to the roll of toilet paper; and (ii) a storage position behind the toilet seat when not in use. The dispenser can be easily installed by first aligning the bolt hole of the proximal horizontal segment with the end of a previously-installed toilet seat bolt, sliding the proximal horizontal segment up the shaft of the mounting bolt through the bolt hole, and then threading and tightening a retaining nut onto the end of the mounting bolt to secure the proximal segment of the dispenser beneath the rear deck of the fixture.

While the nature and advantages of the present invention will be more fully appreciated from the following drawings and detailed description, showing the contemplated novel combinations and elements as herein described, and more particularly defined by the appended claims, it is understood that changes in the precise embodiments of the present invention are meant to be included within the scope of the claims.

### BRIEF DESCRIPTION OF THE DRAWINGS

The accompanying drawings illustrate embodiments of the invention and, together with a general description given above and the detailed description given below, serve to explain the principles of the invention.

FIG. 1 is a perspective view of one embodiment of the one-piece toilet paper dispenser of the present invention;

FIG. 2 is a top plan view of a typical sanitary toilet bowl fixture equipped with the dispenser of FIG. 1;

FIG. 3A is a perspective view of the dispenser of FIG. 1 attached to a toilet bowl fixture and rotated to an extended position;

FIG. 3B shows the dispenser of FIG. 3A rotated to a storage position;

FIG. 4 is a perspective view showing how the dispenser is attached to the underside of a toilet seat fixture;

FIG. 5 is a side view of one embodiment of the inventive dispenser having an attached fragrance bar and night light compartment;

FIG. 6 is a perspective view of the underside of the dispenser in FIG. 5;

FIG. 7 is a perspective view of an optional plastic cover attached to the dispenser.

### DETAILED DESCRIPTION OF THE INVENTION

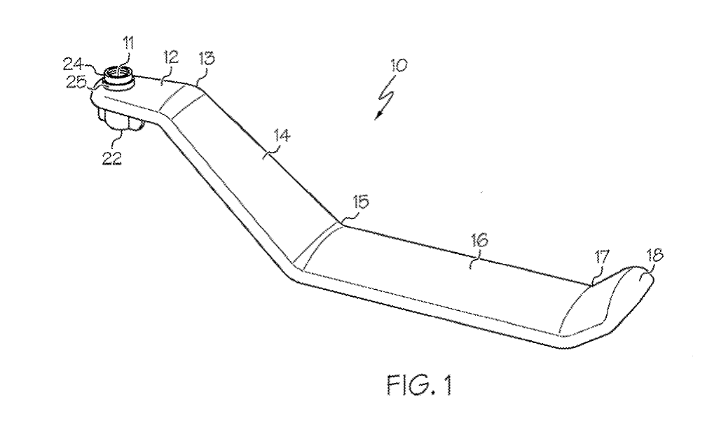

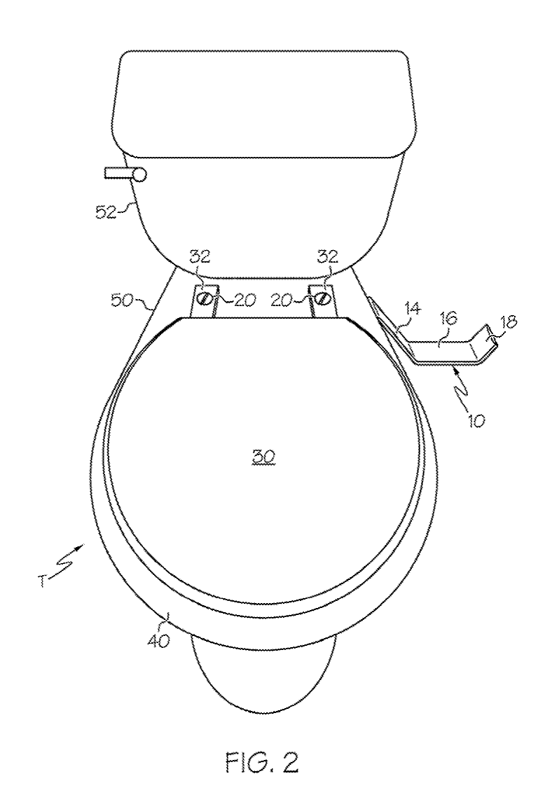

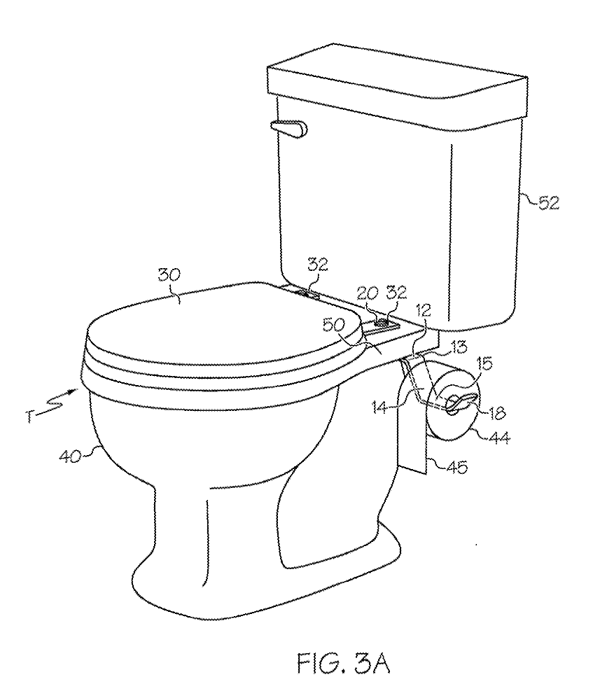

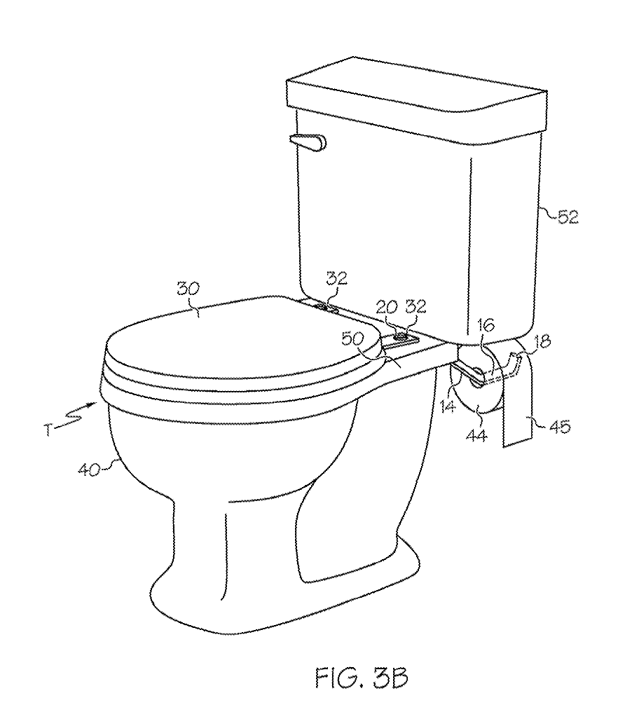

With reference to the drawings wherein like elements are designated by like numerals, FIGS. 1-7 generally illustrate a toilet paper dispenser 10 which can be mounted to the underside of the rear deck 50 of a toilet bowl fixture via the existing mounting bolt 20 for the toilet seat, where it can quickly and easily be rotated by a user between an extended “use” position (FIGS. 2, 3A) and a storage position (FIG. 3B) behind the toilet seat when not in use.

FIG. 1 shows one embodiment of the one-piece toilet paper dispenser 10 having a proximal horizontal segment 12 including an eye or bolt hole 11 for receiving a mounting bolt for a toilet seat. A first bend 13 transitions the proximal segment 12 to a descending segment 14, which directs the dispenser in an outwards and downwards direction prior to transitioning via bend 15 to a distal horizontal segment 16. The distal horizontal segment 16 receives a roll of toilet paper, and a distal ascending segment 18 can be included to prevent the roll from falling off the distal horizontal segment 16 of the dispenser 10. Bends 13, 15 and 17 aid in transitioning between the various segments 12, 14, 16 and 18 of the dispenser, and all bends and segments are made of a single piece construction. A wing nut 22 which includes an extension or bushing 24 that fits within the inside circumference of the bolt hole 11 can be included for quick mounting.

FIGS. 2, 3A and 3B illustrate a toilet bowl fixture designated by the letter T which includes a toilet howl 40 having a rear deck 50 and a water tank 52. A toilet seat 30 is secured to the top of the bowl 40 by means of two mounting bolts 20, Two mounting plates 32 are hinged to the seat 30 and secured by the bolts 20 to the rear deck 50. The bolts 20 each pass through aligned bolt holes in a corresponding one of the mounting plates 32 and in the rear deck 50 of the toilet fixture T. Each mounting bolt 20 typically has a bolt head above the plate and a threaded shaft which passes through the aligned openings and engages a threaded retaining nut underneath the rear deck 50. Retaining nuts for toilet seat mounting bolts are well-known in the art, and typically mate with the mounting bolt 20 via threaded ridges that seal and tighten against the underside of deck 50 to secure the toilet plates 32 in place against the top side of the deck 50, and thus the seat 30 to the top side of the bowl 40.

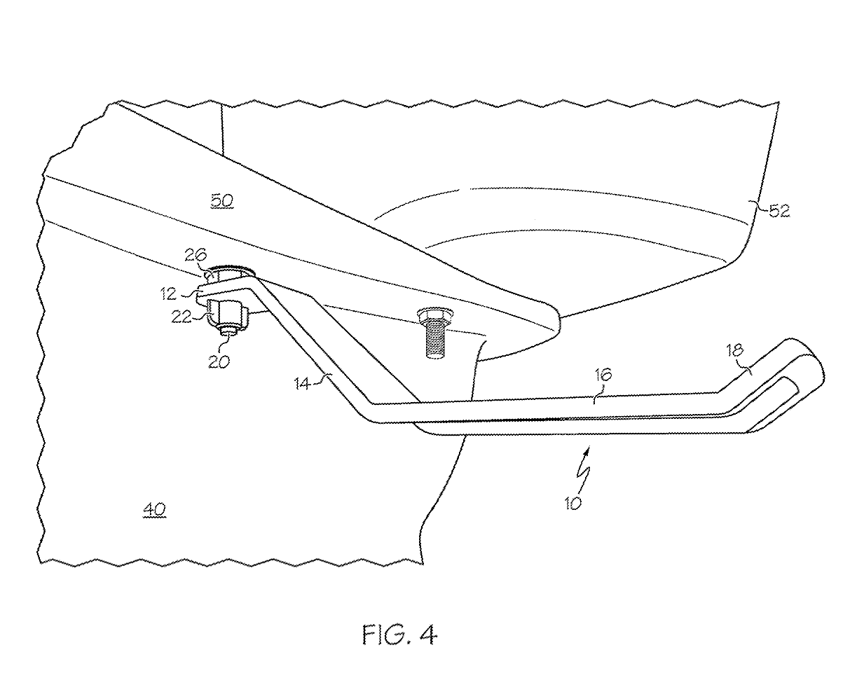

The dispenser 10 can be quickly and easily mounted to the toilet bowl fixture T by first finding the shaft of one of the two mounting bolts 20 which have been previously installed, as described above, as it projects downward beneath the rear deck 50 of the toilet bowl 40. See FIG. 4. The user then aligns the bolt hole 11 of the proximal horizontal segment 12 with the threaded shaft of the bolt 20, and slides the proximal horizontal segment 12 up the shaft of the bolt 20, through the bolt hole 11. A threaded retaining nut, shown in FIGS. 1, 4 and 5 in the form of a threaded wing nut 22, is then threaded and tightened onto the mounting bolt 20 to secure the dispenser 10 beneath the rear deck 50 of the fixture T. The mounting bolt 20 and its associated retaining nut 26 typically do not need to be removed from the fixture T in order to install the inventive dispenser 10, Since the threaded shaft of a conventional mounting bolt 20 is typically between 0.5 inches and 1.0 inches in length, a user can simply slide the dispenser 10 over the end of the bolt shaft as it projects downwardly beneath the toilet deck 50, and then screw a second retaining nut, such as wing nut 22 having and extension or bushing 24, onto the end of the bolt 20 to secure the dispenser 10 to the toilet fixture T.

If the user finds that the shaft of the mounting bolt 20 is not long enough to accommodate the thicknesses of: (1) the existing retaining nut securing the toilet seat bolt, (2) the proximal horizontal segment 12, and (3) a second retaining nut, then the dispenser can be installed by first removing the existing retaining nut 26 prior to sliding the proximal horizontal segment 12 of the dispenser onto the shaft of the mounting bolt 20, and then securing the dispenser 10 with either of the first or second retaining nuts 26, 22 to securely affix the dispenser 10 to the underside of the rear deck 50 of the toilet bowl fixture T. The “second” retaining nut or wing nut 22 can be pre-manufactured and sold to go along with the dispenser 10. The bushing 24 is an extension of the wing nut 22, and sealingly fits between the shaft of the bolt 20 and the inside circumference of the bolt hole 11 so that the dispenser 10 is secured to yet rotatable about the axis of the mounting bolt 20.

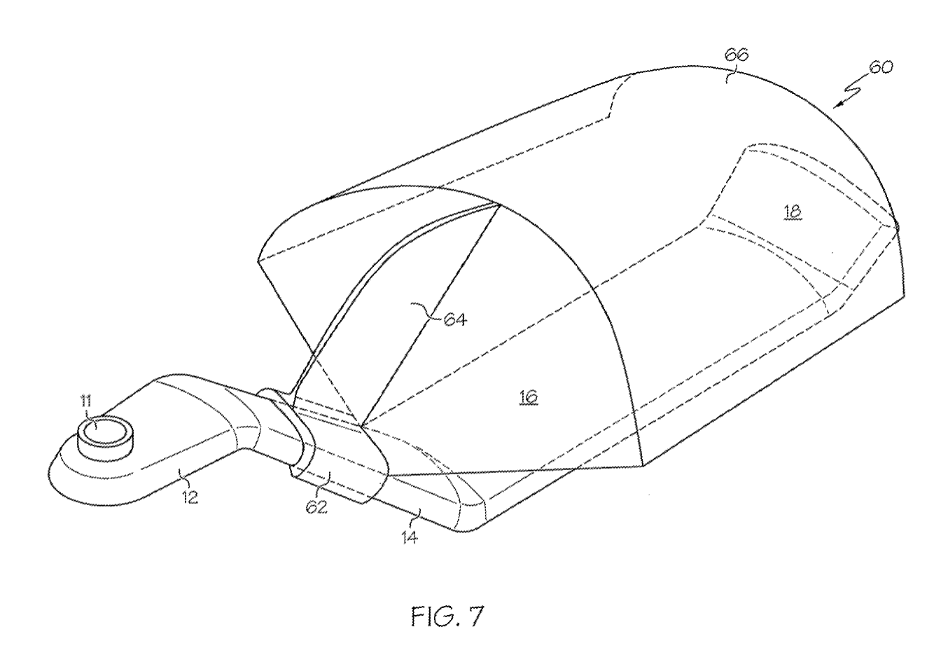

Once the proximal horizontal segment 12 is secured by the mounting bolt 20 as described above, a user can adjustably rotate the one-piece dispenser 10 between an extended position alongside the toilet seat 30 as shown, e.g., in FIG. 2 and FIG. 3A, and a storage position behind the toilet seat, as shown in FIG. 3B. The dispenser's descending segment 14 makes a downward turn at bend 13, in order to offset the distal horizontal segment 16 laterally alongside the toilet seat 30 when in the extended position (see, e.g., FIG. 3A). The descending segment 14 proceeds for a certain length to bend 15, which levels out the one-piece dispenser 10 to a substantially horizontal position throughout the length of the distal horizontal segment 16, The distal horizontal segment 16 is intended to receive and secure a conventional roll 44 of toilet paper along its length, this length being sufficient to pass entirely through the hollow core of a conventional roll of toilet tissue 44. Further, segment 16 is typically of a width that allows the user to unroll the toilet roll 44 by pulling on the final/end tissue 45 of the roll 44, yet does not allow the roll 44 to unravel unassisted, i.e. the roll stops rotating when the user stops pulling end tissue 45. As best appreciated by viewing FIG. 1 and FIG. 7, the top surface and edges of the distal horizontal segment 16 can be rounded, to allow for easier rotation of the roll 44.

The toilet paper roll 44 is inserted onto the dispenser 10 by sliding the roll over the open end of the dispenser. The open end of the dispenser can include the distal ascending segment 18, bend 17, and the distal horizontal segment 16. The upward turn of the dispenser at bend 17 is intended to help retain the toilet roll 44 in position and/or prevent the roll 44 from sliding off the end of the dispenser 10. Both the distal ascending segment 18 and the distal horizontal segment 16 are dimensioned to pass conveniently through the hollow core of the roll 44, and as noted above can have rounded top surfaces to assist with easy rotation of the roll about the dispenser. In one embodiment, the distal ascending segment 18 can be slightly wider than the inner circumference of a conventional toilet paper roll and/or have ridges extending outward that are wider than the circumference of the hollow core of the roll, such that the toilet paper roll 44 may have to be slightly pinched or compressed by the user to allow the hollow core of the roll 44 to fit over the distal end 18 during insertion.

As a non-limiting example, the distal ascending segment 18 can be between 1.7 inches and 1.85 inches wide, the distal horizontal segment 16 can be between 1.5 inches and 1.7 inches wide, and the descending segment 14 can be between 0.5 inches and 1.5 inches wide. The descending segment 14 typically tapers in width from bend 15 at its connection to the distal segment 16 back to bend 13 at the connection to the proximal horizontal segment 12. For example, the descending segment can be about 1.5 inches wide at bend 15 and taper to between about 0.75 inches to about 1.0 inches in width at bend 13. The proximal horizontal segment 12 can be between 0.5 inches and 0.75 inches wide, and can be rounded at its end to assist in rotation about the seat bolt 20. While these dimensions are preferred, it is noted that the dispenser 10 can also be manufactured such that all segments are of the same width.

The amount of vertical drop and horizontal clearance provided the descending segment 14 between bends 13 and 15 should he enough to allow the distal horizontal segment 16 to fit behind the toilet seat 30 and beneath the toilet tank 52 when in the storage position (see FIG. 3B). As a non-limiting example, this can be preferentially accomplished when the proximal horizontal segment 12 from its end to the bend 13 is between 1.0 inches and 2.0 inches in length, the angle of bends 13 and 15 are between 40 degrees and 50 degrees, the horizontal clearance length of the descending segment 14 from bend 13 to bend 15 is between 2.5 inches and 3.0 inches, and the vertical drop of the descending segment 14 from bend 13 to bend 15 is between 1.0 inches and 2.5 inches. The length of segment 16, which begins following bend 15, should be long enough to receive a conventional toilet paper roll, or between 4.0 inches and 5.0 inches; however, it can have dimensions to accept any size roll. As a non-limiting example, the length of the distal ascending segment 18, which begins following bend 17, can be between 0.5 inches and 1.0 inches in length, and the angle of bend 17 can be between zero (0) degrees and 50 degrees. Total length of the dispenser is generally between 8.5 inches and 11.0 inches.

The above non-limiting dimensions are generally sufficient to retain a roll of toilet paper and prevent it from sliding off of the end of the dispenser 10, while keeping the roil of toilet paper within easy reach of the user. Further, while bends 13 and 15 are preferably between 40 degrees and 50 degrees, and while bend 17 is preferably between zero (0) degrees and 50 degrees, all bends can be between zero (0) degrees and 90 degrees; however, the angles and dimensions listed above are most useful for nesting of multiple dispensers together for shipment..

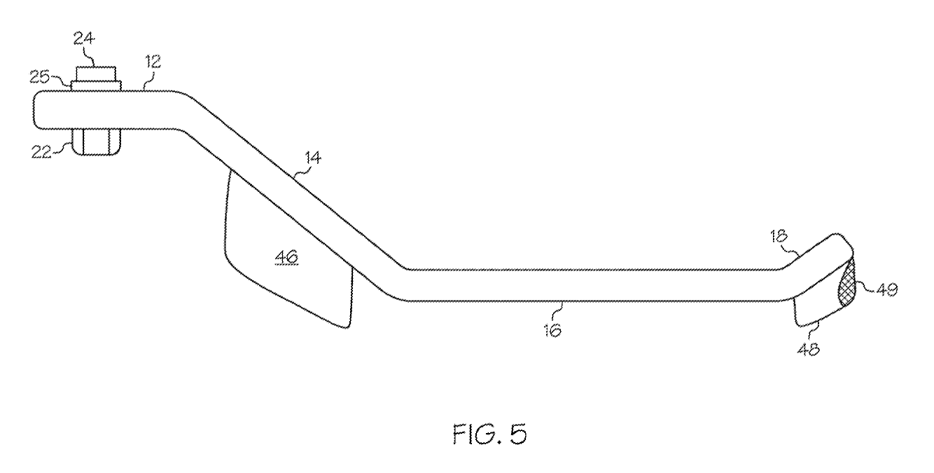

In the embodiment shown in FIGS, 5 and 6, concealed compartments 46, 48 located on the underside of the dispenser 10 can be, or can provide a location for, a fragrance cartridge 46 and/or a motion sensing LED battery-powered night light 48. FIG. 5 also illustrates an embodiment in which the proximal segment 12 includes a raised ridge 25 which is an extension of the edges of the bolt hole 11 (see also FIG. 1). This raised ridge 25 fits snugly with the bushing extension 24 of the threaded retaining nut or wing nut 22, and assists the dispenser to be smoothly and easily rotated between the extended position and the storage position. Though not necessary for installing the dispenser 10, because the existing retaining nut 26 (see FIG. 4) on the bolt 20 can be removed first and then replaced after sliding the dispenser on to the shaft of the mounting bolt 20, the wing nut 22 having the illustrated bushing extension 24 can be included and sold with the dispenser to allow the user to install the dispenser without having to remove the existing mounting bolt 26. The bushing 24 ensures a proper fit with the bolt hole 11 of the dispenser, guaranteeing a smooth rotation between use and storage positions.

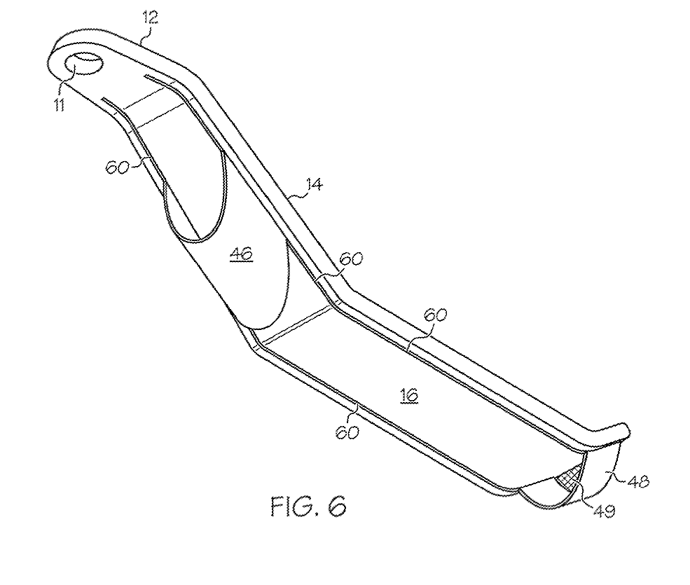

FIG. 6 illustrates the underside of the dispenser 10, with the descending segment 14 including notches or tracks 60 for securing the fragrance bar 46 and night light 48. As shown, the fragrance bar 46 can be a curved deodorizing clip or hood 46 having edges that fit within the tracks 60 on the underside of the descending segment 14. In another embodiment (not shown), the fragrance bar 46 can be designed to clip to the sides of the descending segment 14. In another embodiment (not shown), a portion of, or even the entire dispenser 10 can be a fragrance bar. Fragrance clips and/or bars are known in the art and come in a variety of choices made of recyclable materials that release scents over an extended period of time.

FIGS. 5 and 6 also show a night light assembly 48 attached to the distal ascending segment 18 of the dispenser. The night light 48 can include a motion sensor which can be set to turn on when a user needs to use the bathroom at night. The night light can include a housing or enclosure 48, an electric current supply such as a battery, a motion sensor, and an electrically operated light source 49 such as a light emitting diode (LED) or incandescent light bulb. Such components are well-known in the art and are commercially available. For example, the housing 48 for the night light may be molded from plastic or other suitable material to hold the wiring and connections for one or mom batteries, a motion sensor, and an LED light.

Wires or other electrical coupling may be included with the night light 48 to supply power from the batteries within the housing to the light, motion sensor and/or a control circuit. The motion sensor can include a switch that opens the connection between the light and the motion sensor when it gets dark (so that the light is normally off), and closes the connection (i.e. turns the light on) upon sensing motion in its field of view. The sensor switch could be a thermal, an infrared, or a sonic activated type, so that a person disturbing the field of view will trigger the motion sensor. Appropriate threshold conditions for triggering the motion sensor may be established as is known in the art. Once activated, the light can also be controlled by a control circuit to stay lighted for a predetermined period of time before turning off.

FIG. 7 illustrates an embodiment of the dispenser that includes an attachable cover 60. A fastener 62 of the cover 60 is shaped in the form of a “C” having open, curved ends. A user can hook a first curved end of the fastener 62 around the underside of the dispenser. The fastener 62 can then be rotated until the second end of the “C” hooks around the other underside of the dispenser. The user can then slide the fastener 62 down the tapered descending segment 14 until it becomes wedged into place or otherwise secured at the wider, distal portion of the descending segment 14, near bend 15. The curved ends of the fastener 62 can be designed to fit within the tracks 60 (shown in FIG. 6) on the underside of the descending segment 14. A large rib 64 projects from the fastener 62 and supports a hood portion 66 of the cover, which can envelope and protect a roll of toilet paper inserted onto the dispenser. The fastener 62, rib 64 and hood 66 are of a one-piece construction, and typically of the same material as the dispenser 10.

The inventive toilet paper dispenser, as well as the optional cover 60, wing nut 22, and compartments 46, 48 for a fragrance and/or night light, can be made of any rigid construction materials, such as plastics and metals, of sufficient strength and rigidity to withstand the modest forces required for their operation. Plastics can be formulated to be rigid and exhibit relatively low thermal conductivity compared to other materials. Useful plastics include styrene, acrylonitrile butadiene styrene (ABS), polypropylene, and polycarbonates. Useful metals include stainless steel, aluminum and polished brass, and can be formed from a metal sheet having a thickness such that it can be stamped and/or betided to form the desired configuration. Plastic components can be formed by any process known in the art, such as injection molding, stamping, or 3-dimensional printing. In one embodiment, the plastic can be infused with a fragrant material, such that the entire dispenser emits a fragrance.

It will be appreciated from the foregoing description that the claimed dispenser is simple in construction and can be quickly and easily installed in most conventional toilet bowl fixtures without modification to either the toilet fixture or the toilet seat. The installation does not require any special tools or skills, and is readily reversible without damage to the toilet bowl fixture so that the dispenser can be taken and reinstalled by someone moving to another residence. The dispenser may be easily moved and repositioned from one side of the toilet bowl fixture to the other to suit the convenience of the homeowner and/or to fit the particular toilet installation. It can also be easily moved out of the way when cleaning the bathroom, and can be used as storage for spare or backup rolls of toilet paper. The dispenser is of simple construction and its surfaces are generally accessible for cleaning.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope of the invention.

What is claimed is:

1. A toilet paper dispenser comprising:
a) a proximal horizontal segment for mounting to a toilet bowl fixture via a mounting bolt of a toilet seat;
b) a descending segment; and
c) a distal horizontal segment for receiving a roll of toilet paper, wherein segments (a)-(c) are made of a single piece construction.

2. The toilet paper dispenser of claim 1, further comprising an attachable cover, the cover comprising a fastener for securing the cover to the dispenser, a rib portion projecting from the fastener, and a hood portion connected to the rib portion for protecting a roll of toilet paper.

3. The toilet paper dispenser of claim 1, the proximal horizontal segment including a bolt hole for receiving the mounting bolt, the dispenser further comprising a threaded retaining nut for securing the dispenser to the mounting bolt, wherein the retaining nut includes a bushing that projects between the shaft of the bolt and the inner circumference of the bolt hole.

4. The toilet paper dispenser of claim 1, further comprising:
d) a distal ascending segment for retaining the roll of toilet paper on the distal horizontal segment, wherein segments (a)-(d) are made of a single piece construction.

5. The toilet paper dispenser of claim 1, further comprising a night light assembly.

6. The toilet paper dispenser of claim 5, Wherein the night light assembly comprises a housing for connecting to the distal ascending segment of the toilet paper dispenser, the housing including an electrically operated light source, an electric current supply to energize the light source, and a motion sensor connected between the light source and the electric current supply, the motion sensor configured to sense movement within a field of view and illuminate the light source.

7. The toilet paper dispenser of claim 1, further comprising a fragrance bar for connecting to the toilet paper dispenser.

8. The toilet paper dispenser of claim 7, wherein the underside of the descending segment includes tracks for securing the fragrance bar.

9. A toilet paper dispenser which is rotatable for storage behind the toilet seat when not in use, the dispenser comprising:
a) a proximal horizontal segment for mounting to a toilet bowl fixture via a mounting bolt for a toilet seat, the proximal segment including a. bolt hole for receiving the mounting bolt;
b) a descending segment;
c) a distal horizontal segment for receiving a roll of toilet paper; and
d) a distal ascending segment for retaining the roll of toilet paper on the distal horizontal segment, wherein segments (a)-(d) are made of a single piece construction.

10. The toilet paper dispenser of claim 9, further comprising an attachable cover, the cover comprising a fastener for securing the cover to the dispenser, a rib portion projecting from the fastener, and a hood portion connected to the rib portion for protecting a roll of toilet paper.

11. The toilet paper dispenser of claim 9, further comprising a threaded retaining nut for securing the proximal horizontal segment to the mounting bolt, wherein the retaining nut includes a bushing that projects between the shaft of the bolt and the inner circumference of the bolt hole.

12. The toilet paper dispenser of claim 9, further comprising a night light assembly,

13. The toilet paper dispenser of claim 8, further comprising a fragrance bar, wherein the underside of the descending segment of the toilet paper dispenser includes tracks for securing the fragrance bar.

14. A method of providing easy access to a toilet paper roll, comprising:
a) mounting a toilet paper dispenser to a toilet bowl fixture via a mounting bolt for a toilet seat;
b) attaching a roll of toilet paper to the toilet paper dispenser; and
c) adjustably rotating the dispenser about the mounting bolt between: (i) an extended position alongside the toilet seat for access to the roll of toilet paper; and (ii) a storage position behind the toilet seat when not in use.

15. The method of claim 14, wherein the toilet paper dispenser is made of a single piece construction and comprises a proximal segment including a bolt hole for receiving the mounting bolt, a descending segment, a distal horizontal segment for holding the roll of toilet paper, and a distal ascending segment for retaining the roll of toilet paper on the distal horizontal segment.

16. The method of claim 14, wherein the step of mounting the toilet paper dispenser comprises the following sequential steps:
i) aligning the bolt hole of the proximal horizontal segment with the shaft of the mounting bolt;
ii) sliding the proximal horizontal segment up the shaft of the mounting bolt, the mounting bolt passing through the bolt hole;
iii) threading a retaining nut onto the end of the mounting bolt; and
iv) tightening the retaining nut to the mounting bolt to secure the dispenser to the toilet fixture.

17. The method of claim 16, further comprising the step of first removing an existing retaining nut securing the mounting bolt to the toilet seat, prior to the step of aligning the bolt hole of the proximal horizontal segment with the mounting bolt.

16. The method of claim 16, wherein the step of attaching a roll of toilet paper to the toilet paper dispenser comprises sliding the hollow core of the toilet paper roll over the distal segments of the dispenser.
